(19) United States
(12) Patent Application Publication
(10) Pub. No.: US 2019/0188736 A1
(43) Pub. Date: Jun. 20, 2019

(54) METHODS AND APPARATUS FOR ESTIMATING A LORENZ CURVE FOR A DATASET BASED ON A FREQUENCY VALUE ASSOCIATED WITH THE DATASET

(71) Applicant: The Nielsen Company (US), LLC, New York, NY (US)

(72) Inventors: Michael Sheppard, Holland, MI (US); Ludo Daemen, Duffel (BE)

(21) Appl. No.: 16/246,229

(22) Filed: Jan. 11, 2019

Related U.S. Application Data
(63) Continuation of application No. 15/371,817, filed on Dec. 7, 2016, now abandoned.

(51) Int. Cl. G06Q 30/02; G06F 17/18

(52) U.S. Cl. CPC G06Q 30/0201; G06F 17/18

(57) ABSTRACT

Methods and apparatus for estimating a Lorenz curve for a dataset based on a frequency value associated with the dataset are disclosed. An example apparatus for estimating a Lorenz curve for a dataset representing a distribution of products for individual members of a population includes a frequency identifier and a Lorenz curve generator. The frequency identifier is to access a frequency value associated with the dataset. The frequency value is derived from an occurrence value associated with the products of the dataset and a population value associated with the individual members of the population of the dataset. The frequency identifier is to access the frequency value without directly accessing the occurrence value and the population value. The Lorenz curve generator is to generate an estimated Lorenz curve for the dataset using a Lorenz curve estimation function including the frequency value.

### RELATED APPLICATIONS

This application arises from a continuation of U.S. patent application Ser. No. 15/371,817, filed Dec. 7, 2016, titled “Methods And Apparatus For Estimating A Lorenz Curve For A Dataset Based On A Frequency Value Associated With The Dataset.” The entirety of U.S. patent application Ser. No. 15/371,817 is hereby incorporated by reference herein.

### FIELD OF THE DISCLOSURE

This disclosure relates generally to methods and apparatus for estimating a Lorenz curve for a dataset and, more specifically, to methods and apparatus for estimating a Lorenz curve for a dataset based on a frequency value associated with the dataset.

### BACKGROUND

Lorenz curves are conventionally used in economics to represent distributions of earned income for corresponding populations of income earners. Lorenz curves of the aforementioned type are typically generated based on earned income data respectively obtained (e.g., via a survey) from individual income earners within a substantial population of income earners (e.g., thousands of individual income earners, millions of individual income earners, etc.).

### BRIEF DESCRIPTION OF THE DRAWINGS

FIG. 1 is a graph of a distribution of earned income for a population of income earners.

FIG. 2 is a block diagram of an example Lorenz curve estimation apparatus constructed in accordance with the teachings of this disclosure.

FIG. 3 is an example graph including an example estimated Lorenz curve generated by the example Lorenz curve generator of FIG. 2.

FIG. 4 is a flowchart representative of example machine readable instructions that may be executed at the example Lorenz curve estimation apparatus of FIG. 2 to generate an estimated Lorenz curve for a dataset based on a frequency value associated with the dataset.

FIG. 5 is an example processor platform capable of executing the instructions of FIG. 4 to implement the example Lorenz curve estimation apparatus of FIG. 2.

Certain examples are shown in the above-identified figures and described in detail below. In describing these examples, identical reference numbers are used to identify the same or similar elements. The figures are not necessarily to scale and certain features and certain views of the figures may be shown exaggerated in scale or in schematic for clarity and/or conciseness.

### DETAILED DESCRIPTION

While Lorenz curves are conventionally used in economics to represent distributions of earned income for corresponding populations of income earners, Lorenz curves may also be used in marketing and/or data science to represent other distributions of other assets. For example, a Lorenz curve may be used to represent a distribution of products purchased by a population of product purchasers. Regardless of the type of distribution to be represented by the Lorenz curve, the process of generating the Lorenz curve typically involves accessing data (e.g., earned income data, purchased product data, etc.) respectively obtained (e.g., via a survey) from individuals within a substantial population (e.g., thousands of individual income earners or product purchasers, millions of individual income earners or product purchasers, etc.).

In many instances, the granular data obtained from individual members of the population is confidential and/or private. In such instances, the data obtained from the individual members of the population is not to be shared with and/or provided to entities other than the entity that initially collected the data. In some instances, the confidential and/or private nature of the data may extend to aggregated data for the population, even when the aggregated data may not specifically identify and/or describe individual members of the population. For example, a data collection entity may be willing to share a frequency value associated with a dataset (e.g., an average number of products purchased by each product purchaser within a population of product purchasers) with a third party. The data collection entity may be unwilling, however, to share data from which the frequency value was derived, such as the total number of purchased products (e.g., an aggregated number of purchased products), the total number of product purchasers (e.g., an aggregated number of product purchasers), and/or the underlying data obtained from the individual members of the population.

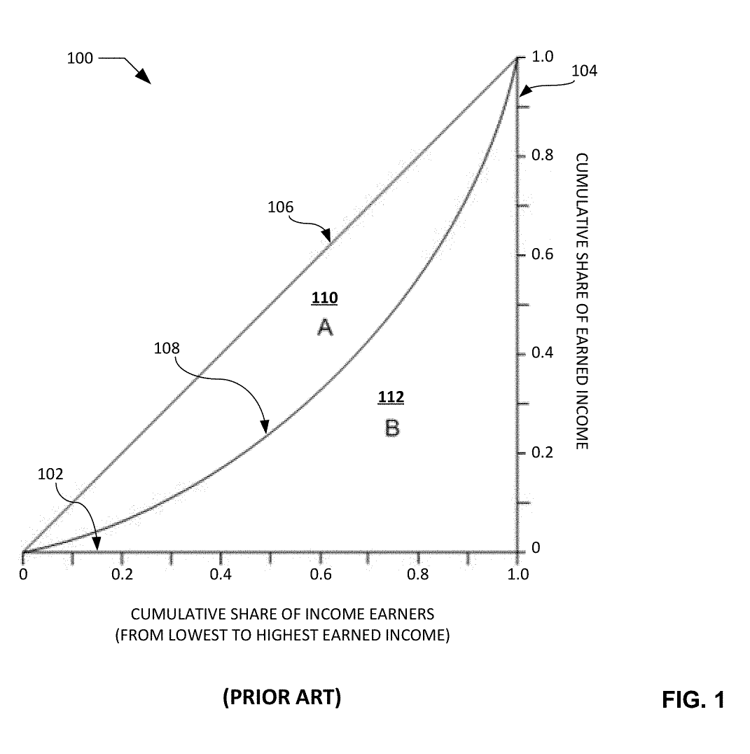

An entity (e.g., an entity other than the data collection entity) desiring to generate a Lorenz curve for a dataset may be impeded by the unwillingness of the data collection entity to share the data from which the frequency value was derived. Methods and apparatus disclosed herein advantageously enable the generation of an estimated Lorenz curve for a dataset based only on a frequency value associated with the dataset. As a result of the disclosed methods and apparatus, any confidentiality and/or privacy concern(s) associated with accessing the underlying data obtained from the individual members of the population is/are reduced and/or eliminated. By enabling the generation of an estimated Lorenz curve for a dataset based only on a frequency value associated with the dataset, the disclosed methods and apparatus further provide a computational advantage relative to the voluminous processing and/or storage loads associated with conventional methods for generating a Lorenz curve. Before describing the details of example methods and apparatus for estimating a Lorenz curve for a dataset based on a frequency value associated with the dataset, a description of a conventional Lorenz curve representing a distribution of earned income for a population of income earners is provided in connection with FIG. 1.

FIG. 1 is a graph 100 of a distribution of earned income for a population of income earners. The graph 100 includes an x-axis 102 indicative of the cumulative share of income earners arranged from lowest to highest earned income, and a y-axis 104 indicative of the cumulative share of earned income. The graph 100 further includes a line of equality 106 and a Lorenz curve 108. The line of equality 106 is a graphical representation of a distribution of perfect equality as would exist, for example, in a scenario where each member (e.g., each person) of the population earns the exact same income as every other member of the population. The Lorenz curve 108 is a graphical representation of the actual distribution of earned income for the population of income earners. The Lorenz curve 108 of FIG. 1 is generated (e.g., plotted) based on data obtained from individual income earners. For example, the Lorenz curve 108 may be generated based on earned income data respectively obtained (e.g., via a survey) from the individual income earners within a substantial population of income earners (e.g., thousands of individual income earners, millions of individual income earners, etc.).

In the illustrated example of FIG. 1, the extent by which the Lorenz curve 108 deviates from the line of equality 106 provides an indication of the extent by which the distribution of earned income for the population of income earners is unequal (e.g., a measure of inequality). For example, the Lorenz curve 108 defines a first area “A” 110 between the line of equality 106 and the Lorenz curve 108, and a second area “B” 112 between the Lorenz curve 108, the x-axis 102 and the y-axis 104 (e.g., an area under the Lorenz curve). As the extent by which the Lorenz curve 108 deviates from the line of equality 106 increases, the first area “A” 110 increases in size, and the second area “B” 112 decreases in size. A ratio known as the Gini index may be calculated as the size (e.g., area) of the first area “A” 110 divided by the sum of the sizes (e.g., areas) of the first area “A” 110 and the second area “B” 112 combined. The Gini index may alternatively be calculated as (2×A), where “A” is the first area 110, or as (1−(2×B)), where “B” is the second area 112. As the calculated Gini index and/or the ratio of the first area “A” 110 to the second area “B” 112 increases, so too does the extent of inequality of the distribution.

Although the Lorenz curve 108 of FIG. 1 represents a distribution of earned income for a population of income earners, Lorenz curves may be used to represent other distributions of other assets. For example, a Lorenz curve may represent a distribution of products purchased by a population of product purchasers. As another example, a Lorenz curve may represent a distribution of webpages visited by a population of webpage viewers. As another example, a Lorenz curve may represent a distribution of media content viewed by a population of media content viewers.

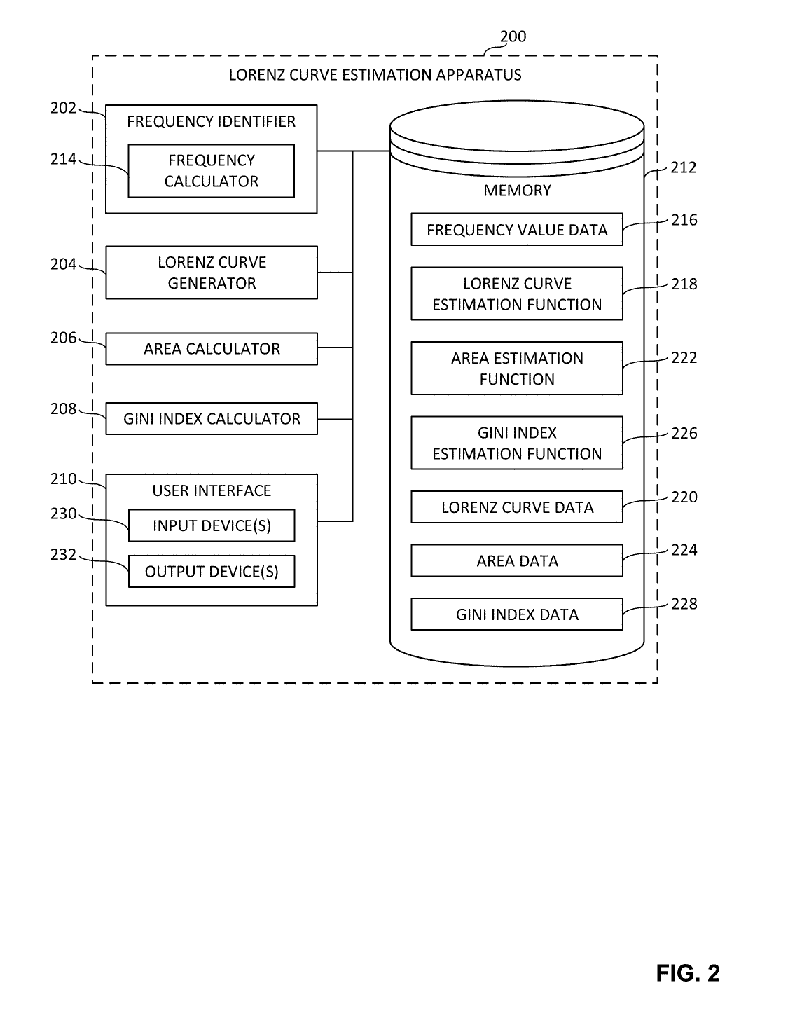

FIG. 2 is a block diagram of an example Lorenz curve estimation apparatus 200 constructed in accordance with the teachings of this disclosure. In the illustrated example of FIG. 2, the Lorenz curve estimation apparatus 200 includes an example frequency identifier 202, an example Lorenz curve generator 204, an example area calculator 206, an example Gini index calculator 208, an example user interface 210, and an example memory 212. However, other example implementations of the Lorenz curve estimation apparatus 200 may include fewer or additional structures.

The example frequency identifier 202 of FIG. 2 identifies and/or determines a frequency value associated with a dataset. The frequency value identified and/or determined by the frequency identifier 202 may correspond to an average frequency at which an event occurs for each member of a population. For example, the frequency value may be an average number of products purchased by each product purchaser within a population of product purchasers. As another example, the frequency value may be an average number of webpages visited by each webpage visitor within a population of product purchasers. As another example, the frequency value may be an average number of items of media content viewed by each media content viewer within a population of media content viewers.

The frequency identifier 202 of FIG. 2 includes an example frequency calculator 214. The example frequency calculator 214 of FIG. 2 calculates a frequency value associated with the dataset based on an occurrence value associated with the dataset and a population value associated with the dataset. For example, the frequency calculator 214 may divide a total number of products purchased by a total number of product purchasers to yield a frequency value corresponding to an average number of products purchased by each product purchaser within the population of product purchasers. As another example, the frequency calculator 214 may divide a total number of webpages visited by a total number of webpage visitors to yield a frequency value corresponding to an average number of webpages visited by each webpage visitor within the population of webpage visitors. As another example, the frequency calculator 214 may divide a total number of items of media content viewed by a total number of media content viewers to yield a frequency value corresponding to an average number of items of media content viewed by each media content viewer within the population of media content viewers.

Example frequency value data 220 identified, calculated and/or determined by the frequency identifier 202 and/or the frequency calculator 214 of FIG. 2 may be of any type, form and/or format, and may be stored in a computer-readable storage medium such as the example memory 212 of FIG. 2 described below. In some examples, the frequency identifier 202 and/or the frequency calculator 214 of FIG. 2 may identify, calculate and/or determine a frequency value associated with a dataset by accessing and/or obtaining the example frequency value data 216 stored in the example memory 212 of FIG. 2. In other examples, the frequency identifier 202 and/or the frequency calculator 214 may identify, detect, calculate and/or determine a frequency value associated with a dataset based on frequency value data carried by one or more signal(s), message(s) and/or command(s) received via the user interface 210 of FIG. 2 described below. In some examples, a third party (e.g., a party other than the operator of the Lorenz curve estimation apparatus 200 of FIG. 2) may provide the frequency identifier 202, the frequency calculator 214 and/or, more generally, the Lorenz curve estimation apparatus 200 of FIG. 2, with access to the frequency value associated with the dataset, and/or to data from which the frequency value associated with the dataset may be calculated.

The example Lorenz curve generator 204 of FIG. 2 generates an estimated Lorenz curve for the dataset based on a Lorenz curve estimation function including the frequency value associated with the dataset. For example, the Lorenz curve generator 204 may generate an estimated Lorenz curve for the dataset based on a Lorenz curve estimation function having the form:

$$y = x - \frac{( 1 - x ) log ( 1 - x )}{f log ( 1 - \frac{1}{f} )} \qquad Equation ( 1 )$$

where f is the frequency value associated with the dataset.

Thus, when a frequency value associated with a dataset is identified, the Lorenz curve estimation function corresponding to Equation 1 may be utilized to determine a y-coordinate value of the estimated Lorenz curve for the dataset (e.g., a cumulative share of purchased products) for a given x-coordinate value of the estimated Lorenz curve for the dataset (e.g., a cumulative share of product purchasers).

In some examples, the Lorenz curve estimation function corresponding to Equation 1 above may be derived from a maximum entropy distribution function. In some examples, the maximum entropy distribution function has the form:

$$N ( k ) = \{ \begin{matrix}U - A , & if k = 0. \\ \frac{{A}^{2}}{R - A} {( 1 - \frac{A}{R} )}^{k} , & otherwise .\end{matrix} \qquad Equation ( 2 )$$

where U is a universe estimate of a number of people, A is a number of unique people from among U, R is a cumulative number of products purchased, and k is an exact number of products purchased by an individual from among A.

Based on Equation 2 described above, the cumulative number of people who purchased up to M products may be expressed as:

$$\begin{matrix}{N}_{TOTAL} ( M ) = {\sum }_{k = 1}^{M} \frac{{A}^{2}}{R - A} {( 1 - \frac{A}{R} )}^{k} \\ = A - {A ( 1 - \frac{A}{R} )}^{M}\end{matrix} \qquad Equation ( 3 )$$

where A is a number of unique people, R is a cumulative number of products purchased, k is an exact number of products purchased by an individual from among A, and M is a threshold number of products purchased by a cumulative number of people among A.

Dividing Equation 3 described above by A and applying the relationship f=R/A yields an x-coordinate function that may be expressed as:

$$x = 1 - {( 1 - \frac{1}{f} )}^{M} \qquad Equation ( 4 )$$

where f is a frequency value associated with the dataset (e.g., an average number of products purchased by each product purchaser within the population of product purchasers), and M is a threshold number of products purchased by a cumulative number of people among A.

The x-coordinate function corresponding to Equation 4 provides an expression for the x-coordinate. For example, the x-coordinate function corresponding to Equation 4 may be utilized to determine the cumulative fraction of the purchasers who individually purchased up to M products.

The total number of products purchased by the cumulative fraction of purchasers can also be determined. For example, based on Equation 2 described above, the total number of products purchased by purchasers who individually purchased up to M products may be expressed as:

$$\begin{matrix}{W}_{TOTAL} ( M ) = {\sum }_{k = 1}^{M} k \frac{{A}^{2}}{R - A} {( 1 - \frac{A}{R} )}^{k} \\ = R - ( AM + R ) {( 1 - \frac{A}{R} )}^{M}\end{matrix} \qquad Equation ( 5 )$$

where A is a number of unique people, R is a cumulative number of products purchased, k is an exact number of products purchased by an individual from among A, and M is a threshold number of products purchased by a cumulative number of people among A.

Dividing Equation 5 described above by R and applying the relationship f=R/A yields a y-coordinate function that may be expressed as:

$$y = 1 - ( 1 + \frac{M}{f} ) {( 1 - \frac{1}{f} )}^{M} \qquad Equation ( 6 )$$

where f is a frequency value associated with the dataset (e.g., an average number of products purchased by each product purchaser within the population of product purchasers), and M is a threshold number of products purchased by a cumulative number of people among A.

The y-coordinate function corresponding to Equation 6 provides an expression for the y-coordinate. For example, the y-coordinate function corresponding to Equation 6 may be utilized to determine the cumulative fraction of the total products purchased by purchasers who individually purchased up to M products.

Equation 4 and Equation 6 described above provide a set of parametric equations that are functions of M. The Lorenz curve estimation function corresponding to Equation 1 described above may be derived by solving Equation 4 for M and substituting the resultant expression for M into Equation 6. Utilizing the Lorenz curve estimation function corresponding to Equation 1, the Lorenz curve generator 204 of FIG. 2 is advantageously able to generate an estimated Lorenz curve for a dataset based only on a frequency value associated with the dataset.

An example Lorenz curve estimation function 218 (e.g., the Lorenz curve estimation function corresponding to Equation 1 above) utilized by the Lorenz curve generator 204 of FIG. 2 may be stored in a computer-readable storage medium such as the example memory 212 of FIG. 2 described below. Example Lorenz curve data 220 generated by the Lorenz curve generator 204 of FIG. 2 may be of any type, form and/or format, and may be stored in a computer-readable storage medium such as the example memory 212 of FIG. 2 described below.

In some examples, the estimated Lorenz curve generated by the Lorenz curve generator 204 of FIG. 2 may represent an estimated distribution of products purchased by a population of product purchasers. In other examples, the estimated Lorenz curve generated by the Lorenz curve generator 204 of FIG. 2 may represent an estimated distribution of webpages visited by a population of webpage viewers. In other examples, the estimated Lorenz curve generated by the Lorenz curve generator 204 of FIG. 2 may represent an estimated distribution of media content viewed by a population of media content viewers.

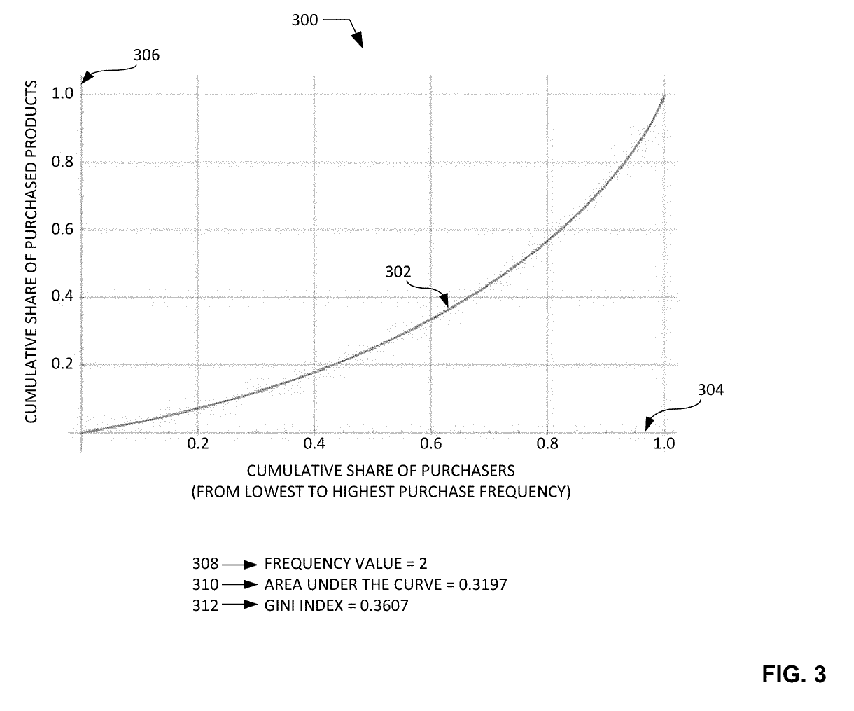

In some examples, the Lorenz curve generator 204 of FIG. 2 generates a graphical representation (e.g., the graph 300 of FIG. 3 described below) to be presented via the example user interface 210 of FIG. 2. In some examples, the graphical representation includes an estimated Lorenz curve generated by the Lorenz curve generator 204 for a dataset. In some examples, the graphical representation includes an area under the estimated Lorenz curve calculated by the area calculator 206 of FIG. 2 described below. In some examples, the graphical representation includes a Gini index for the estimated Lorenz curve calculated by the Gini index calculator 208 of FIG. 2 described below.

The example area calculator 206 of FIG. 2 calculates an area under the estimated Lorenz curve based on an area estimation function including the frequency value associated with the dataset. For example, the area calculator 206 may calculate an area under the estimated Lorenz curve based on an area estimation function having the form:

$$Area = \frac{1}{4} ( 2 + \frac{1}{f log ( 1 - \frac{1}{f} )} ) \qquad Equation ( 7 )$$

where f is the frequency value associated with the dataset.

An example area estimation function 222 (e.g., the area estimation function corresponding to Equation 7 above) utilized by the area calculator 206 of FIG. 2 may be stored in a computer-readable storage medium such as the example memory 212 of FIG. 2 described below. Example area data 224 calculated by the area calculator 206 of FIG. 2 may be of any type, form and/or format, and may be stored in a computer-readable storage medium such as the example memory 212 of FIG. 2 described below. The area data 224 is accessible to the Lorenz curve generator 204 of FIG. 2 from the area calculator 206 and/or from the memory 212 of FIG. 2.

The example Gini index calculator 208 of FIG. 2 calculates a Gini index for the estimated Lorenz curve based on a Gini index estimation function including the frequency value associated with the dataset. For example, the Gini index calculator 208 may calculate a Gini index for the estimated Lorenz curve based on a Gini index estimation function having the form:

$$Gini Index = {( 2 f log ( \frac{f}{f - 1 } ) )}^{- 1} \qquad Equation ( 8 )$$

where f is the frequency value associated with the dataset.

An example Gini index estimation function 226 (e.g., the Gini index estimation function corresponding to Equation 8 above) utilized by the Gini index calculator 208 of FIG. 2 may be stored in a computer-readable storage medium such as the example memory 212 of FIG. 2 described below. Example Gini index data 228 calculated by the Gini index calculator 208 of FIG. 2 may be of any type, form and/or format, and may be stored in a computer-readable storage medium such as the example memory 212 of FIG. 2 described below. The Gini index data 228 is accessible to the Lorenz curve generator 204 of FIG. 2 from the Gini index calculator 208 and/or from the memory 212 of FIG. 2.

The example user interface 210 of FIG. 2 facilitates interactions and/or communications between an end user and the Lorenz curve estimation apparatus 200. The user interface 210 includes one or more input device(s) 230 via which the user may input information and/or data to the Lorenz curve estimation apparatus 200. For example, the one or more input device(s) 230 of the user interface 210 may include a button, a switch, a keyboard, a mouse, a microphone, and/or a touchscreen that enable(s) the user to convey data and/or commands to the Lorenz curve estimation apparatus 200 of FIG. 2. The user interface 210 of FIG. 2 also includes one or more output device(s) 232 via which the user interface 210 presents information and/or data in visual and/or audible form to the user. For example, the one or more output device(s) 232 of the user interface 210 may include a light emitting diode, a touchscreen, and/or a liquid crystal display for presenting visual information, and/or a speaker for presenting audible information. In some examples, the one or more output device(s) 232 of the user interface 210 may present a graphical representation including an estimated Lorenz curve for a dataset, a calculated area under the estimated Lorenz curve, and/or a calculated Gini index for the estimated Lorenz curve. Data and/or information that is presented and/or received via the user interface 210 may be of any type, form and/or format, and may be stored in a computer-readable storage medium such as the example memory 212 of FIG. 2 described below.

The example memory 212 of FIG. 2 may be implemented by any type(s) and/or any number(s) of storage device(s) such as a storage drive, a flash memory, a read-only memory (ROM), a random-access memory (RAM), a cache and/or any other physical storage medium in which information is stored for any duration (e.g., for extended time periods, permanently, brief instances, for temporarily buffering, and/or for caching of the information). The information stored in the memory 212 may be stored in any file and/or data structure format, organization scheme, and/or arrangement. The memory 212 is accessible to one or more of the example frequency identifier 202, the example Lorenz curve generator 204, the example area calculator 206, the example Gini index calculator 208 and/or the example user interface 210 of FIG. 2, and/or, more generally, to the Lorenz curve estimation apparatus 200 of FIG. 2.

In some examples, the memory 212 of FIG. 2 stores data and/or information received via the one or more input device(s) 230 of the user interface 210 of FIG. 2. In some examples, the memory 212 stores data and/or information to be presented via the one or more output device(s) 232 of the user interface 210 of FIG. 2. In some examples, the memory 212 stores data from which a frequency value associated with a dataset may be calculated and/or determined by the frequency calculator 214 of FIG. 2 and/or, more generally, by the frequency identifier 202 of FIG. 2. In some examples, the memory 212 stores a frequency value (e.g., the frequency value data 216 of FIG. 2) associated with a dataset. In some examples, the memory 212 stores one or more mathematical function(s) and/or expression(s) (e.g., the Lorenz curve estimation function 218 of FIG. 2) from which an estimated Lorenz curve for a dataset may be generated based on a frequency value associated with the dataset. In some examples, the memory 212 stores one or more mathematical function(s) and/or expression(s) (e.g., the area estimation function 222 of FIG. 2) from which an area under an estimated Lorenz curve for a dataset may be calculated based on a frequency value associated with the dataset. In some examples, the memory 212 stores one or more mathematical function(s) and/or expression(s) (e.g., the Gini index estimation function 226 of FIG. 2) from which a Gini index for an estimated Lorenz curve for a dataset may be calculated based on a frequency value associated with the dataset. In some examples, the memory 212 stores one or more estimated Lorenz curve(s) (e.g., the Lorenz curve data 220 of FIG. 2) generated by the example Lorenz curve generator 204 of FIG. 2, one or more area value(s) (e.g., the area data 224 of FIG. 2) calculated by the example area calculator 206 of FIG. 2, and/or one or more Gini index value(s) (e.g., the Gini index data 228 of FIG. 2) calculated by the example Gini index calculator 208 of FIG. 2.

While an example manner of implementing a Lorenz curve estimation apparatus 200 is illustrated in FIG. 2, one or more of the elements, processes and/or devices illustrated in FIG. 2 may be combined, divided, re-arranged, omitted, eliminated and/or implemented in any other way. Further, the example frequency identifier 202, the example Lorenz curve generator 204, the example area calculator 206, the example Gini index calculator 208, the example user interface 210, the example memory 212, and/or the example frequency calculator 214 of FIG. 2 may be implemented by hardware, software, firmware and/or any combination of hardware, software and/or firmware. Thus, for example, any of the example frequency identifier 202, the example Lorenz curve generator 204, the example area calculator 206, the example Gini index calculator 208, the example user interface 210, the example memory 212, and/or the example frequency calculator 214 of FIG. 2 could be implemented by one or more analog or digital circuit(s), logic circuits, programmable processor(s), application specific integrated circuit(s) (ASIC(s)), programmable logic device(s) (PLD(s)) and/or field programmable logic device(s) (FPLD(s)). When reading any of the apparatus or system claims of this patent to cover a purely software and/or firmware implementation, at least one of the example frequency identifier 202, the example Lorenz curve generator 204, the example area calculator 206, the example Gini index calculator 208, the example user interface 210, the example memory 212, and/or the example frequency calculator 214 of FIG. 2 is/are hereby expressly defined to include a tangible computer-readable storage device or storage disk such as a memory, a digital versatile disk (DVD), a compact disk (CD), a Blu-ray disk, etc. storing the software and/or firmware. Further still, the example Lorenz curve estimation apparatus 200 of FIG. 2 may include one or more elements, processes and/or devices in addition to, or instead of, those illustrated in FIG. 2, and/or may include more than one of any or all of the illustrated elements, processes and devices.

FIG. 3 is an example graph 300 including an example estimated Lorenz curve 302 generated by the example Lorenz curve generator 204 of FIG. 2. The example graph 300 of FIG. 3 may be presented via the one or more output device(s) 232 of the user interface 210 of FIG. 2. The graph 300 of FIG. 3 includes an example x-axis 304 indicative of the cumulative share of purchasers arranged from lowest to highest purchase frequency, and an example y-axis 306 indicative of the cumulative share of purchased products. Thus, the estimated Lorenz curve 302 of FIG. 3 represents an estimated distribution of products purchased by a population of product purchasers.

In the illustrated example of FIG. 3, the estimated Lorenz curve 302 is generated (e.g., plotted) by the Lorenz curve generator 204 of FIG. 2 based only on a frequency value associated with the dataset to which the graph 300 of FIG. 3 pertains (e.g., products purchased by a population of product purchasers). Thus, the estimated Lorenz curve 302 of FIG. 3 is not generated based on data obtained from individual product purchasers, but is rather based on a frequency value determined from aggregated data for the population of product purchasers as a whole. In the illustrated example of FIG. 3, the estimated Lorenz curve 302 has been generated based on a frequency value equal to 2 (e.g., f=2). The graph 300 of FIG. 3 includes a first example indication 308 (e.g., text) corresponding to the frequency value (e.g., f=2) that the estimated Lorenz curve for the dataset was based on. The graph 300 of FIG. 3 further includes a second example indication 310 (e.g., text) corresponding to the area under the estimated Lorenz curve 302 as calculated by the area calculator 206 of FIG. 2 based on a frequency value equal to 2 (e.g., f=2). In the illustrated example of FIG. 3, the second example indication 310 indicates that the calculated area under the curve is equal to 0.3197. The graph 300 of FIG. 3 further includes a third example indication 312 (e.g., text) corresponding to the Gini index for the estimated Lorenz curve 302 as calculated by the Gini index calculator 208 of FIG. 2 based on a frequency value equal to 2 (e.g., f=2). In the illustrated example of FIG. 3, the third example indication 312 indicates that the calculated Gini index is equal to 0.3607.

Although the estimated Lorenz curve 302 of FIG. 3 represents a distribution of products purchased by a population of product purchasers, the Lorenz curve generator 204 and/or, more generally, the Lorenz curve estimation apparatus 200 of FIG. 2, may generate other estimated Lorenz curves for other distributions of other assets. For example, the Lorenz curve generator 204 may generate an estimated Lorenz curve representing a distribution of webpages visited by a population of webpage viewers. As another example, the Lorenz curve generator 204 may generate an estimated Lorenz curve representing a distribution of media content viewed by a population of media content viewers.

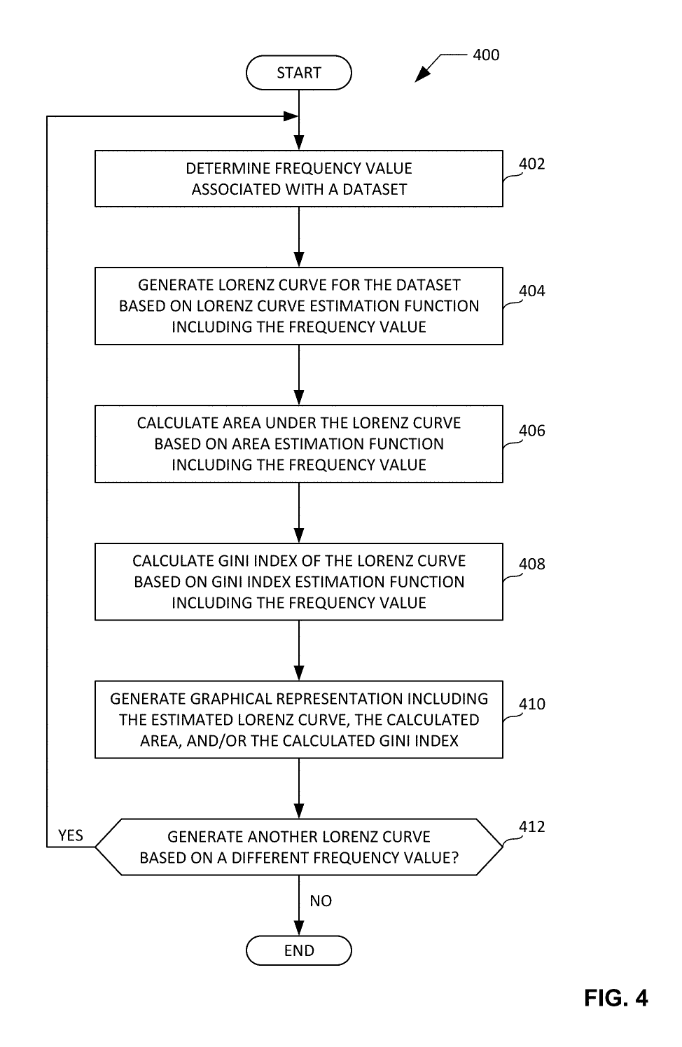

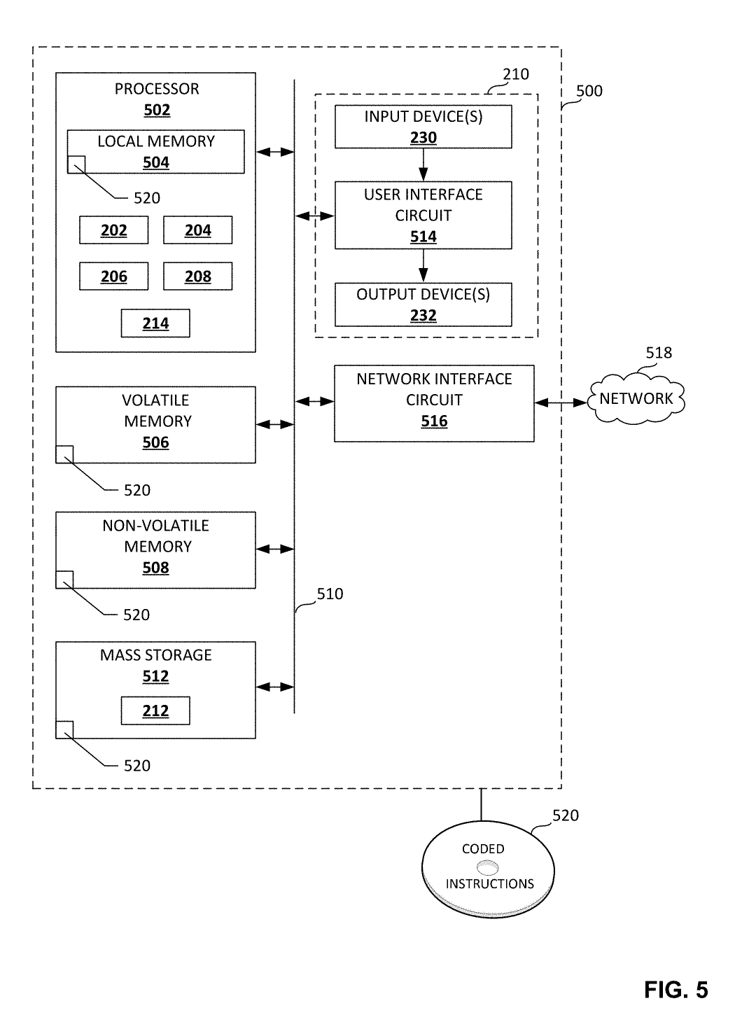

A flowchart representative of example machine readable instructions which may be executed to generate an estimated Lorenz curve for a dataset based on a frequency value associated with the dataset is shown in FIG. 4. In these examples, the machine-readable instructions may implement one or more program(s) for execution by a processor such as the example processor 502 shown in the example processor platform 500 discussed below in connection with FIG. 5. The one or more program(s) may be embodied in software stored on a tangible computer readable storage medium such as a CD-ROM, a floppy disk, a hard drive, a digital versatile disk (DVD), a Blu-ray disk, or a memory associated with the processor 502 of FIG. 5, but the entire program(s) and/or parts thereof could alternatively be executed by a device other than the processor 502 of FIG. 5, and/or embodied in firmware or dedicated hardware. Further, although the example program(s) is/are described with reference to the flowchart illustrated in FIG. 4, many other methods for generating an estimated Lorenz curve for a dataset based on a frequency value associated with the dataset may alternatively be used. For example, the order of execution of the blocks may be changed, and/or some of the blocks described may be changed, eliminated, or combined.

As mentioned above, the example instructions of FIG. 4 may be stored on a tangible computer readable storage medium such as a hard disk drive, a flash memory, a read-only memory (ROM), a compact disk (CD), a digital versatile disk (DVD), a cache, a random-access memory (RAM) and/or any other storage device or storage disk in which information is stored for any duration (e.g., for extended time periods, permanently, for brief instances, for temporarily buffering, and/or for caching of the information). As used herein, the term “tangible computer readable storage medium” is expressly defmed to include any type of computer readable storage device and/or storage disk and to exclude propagating signals and to exclude transmission media. As used herein, “tangible computer readable storage medium” and “tangible machine readable storage medium” are used interchangeably. Additionally or alternatively, the example instructions of FIG. 4 may be stored on a non-transitory computer and/or machine-readable medium such as a hard disk drive, a flash memory, a read-only memory, a compact disk, a digital versatile disk, a cache, a random-access memory and/or any other storage device or storage disk in which information is stored for any duration (e.g., for extended time periods, permanently, for brief instances, for temporarily buffering, and/or for caching of the information). As used herein, the term “non-transitory computer readable medium” is expressly defmed to include any type of computer readable storage device and/or storage disk and to exclude propagating signals and to exclude transmission media. As used herein, when the phrase “at least” is used as the transition term in a preamble of a claim, it is open-ended in the same manner as the term “comprising” is open ended.

FIG. 4 is a flowchart representative of example machine readable instructions 400 that may be executed at the example Lorenz curve estimation apparatus 200 of FIG. 2 to generate an estimated Lorenz curve for a dataset based on a frequency value associated with the dataset. The example program 400 begins when the example frequency identifier 202 of FIG. 2 identifies and/or determines a frequency value associated with a dataset (block 402). For example, the frequency identifier 202 may identify and/or determine a frequency value corresponding to an average frequency at which an event occurs for each member of a population (e.g., an average number of products purchased by each product purchaser within a population of product purchasers). In some examples, the frequency identifier 202 may identify and/or determine the frequency value in response to the frequency calculator 214 of FIG. 2 calculating the frequency value from an occurrence value associated with the dataset and a population value associated with the dataset (e.g., by dividing a total number of products purchased by a total number of product purchasers to yield a frequency value corresponding to an average number of products purchased by each product purchaser within the population of product purchasers). Following block 402, control proceeds to block 404.

At block 404, the example Lorenz curve generator 204 of FIG. 2 generates an estimated Lorenz curve for the dataset based on a curve estimation function including the frequency value associated with the dataset (block 404). For example, the Lorenz curve generator 204 may generate an estimated Lorenz curve for the dataset based on a Lorenz curve estimation function having the form of Equation 1 described above. In some disclosed examples, the Lorenz curve estimation function is derived from a maximum entropy distribution function. In some disclosed examples, the maximum entropy distribution function has the form of Equation 2 described above. Following block 404, control proceeds to block 406.

At block 406, the example area calculator 206 of FIG. 2 calculates an area under the estimated Lorenz curve based on an area estimation function including the frequency value associated with the dataset (block 406). For example, the area calculator 206 may calculate an area under the estimated Lorenz curve based on an area estimation function having the form of Equation 7 described above. Following block 406, control proceeds to block 408.

At block 408, the example Gini index calculator 208 of FIG. 2 calculates a Gini index for the estimated Lorenz curve based on a Gini index estimation function including the frequency value associated with the dataset (block 408). For example, the Gini index calculator 208 may calculate a Gini index for the estimated Lorenz curve based on a Gini index estimation function having the form of Equation 8 described above. Following block 408, control proceeds to block 410.

At block 410, the example Lorenz curve generator 204 of FIG. 2 generates a graphical representation (e.g., the graph 300 of FIG. 3) to be presented via the example user interface 210 of FIG. 2 (block 410). In some examples, the graphical representation includes the estimated Lorenz curve generated by the Lorenz curve generator 204 for the dataset. In some examples, the graphical representation includes the area under the estimated Lorenz curve calculated by the area calculator 206 of FIG. 2. In some examples, the graphical representation includes the Gini index for the estimated Lorenz curve calculated by the Gini index calculator 208 of FIG. 2. Following block 410, control proceeds to block 412.

At block 412, the example Lorenz curve estimation apparatus 200 of FIG. 2 determines whether to generate another Lorenz curve for the dataset based on a different frequency value (block 412). For example, the Lorenz curve estimation apparatus 200 may receive one or more signal(s), command(s) and or instruction(s) via the example user interface 210 of FIG. 2 indicating that the Lorenz curve estimation apparatus 200 is to generate another Lorenz curve for the dataset based on a different frequency value. If the Lorenz curve estimation apparatus 200 determines at block 412 to generate another Lorenz curve for the dataset based on a different frequency value, control returns to block 402. If the Lorenz curve estimation apparatus 200 instead determines at block 412 not to generate another Lorenz curve for the dataset based on a different frequency value, the example program 400 of FIG. 4 ends.

FIG. 5 is an example processor platform 500 capable of executing the instructions 400 of FIG. 4 to implement the example Lorenz curve estimation apparatus 200 of FIG. 2. The processor platform 500 of the illustrated example includes a processor 502. The processor 502 of the illustrated example is hardware. For example, the processor 502 can be implemented by one or more integrated circuit(s), logic circuit(s), controller(s), microcontroller(s) and/or microprocessor(s) from any desired family or manufacturer. The processor 502 of the illustrated example includes a local memory 504 (e.g., a cache). The processor 502 of the illustrated example also includes the example frequency identifier 202, the example Lorenz curve generator 204, the example area calculator 206, the example Gini index calculator 208, and the example frequency calculator 214 of FIG. 2.

The processor 502 of the illustrated example is also in communication with a main memory including a volatile memory 506 and a non-volatile memory 508 via a bus 510. The volatile memory 506 may be implemented by Synchronous Dynamic Random Access Memory (SDRAM), Dynamic Random Access Memory (DRAM), RAMBUS Dynamic Random Access Memory (RDRAM) and/or any other type of random access memory device. The non-volatile memory 508 may be implemented by flash memory and/or any other desired type of memory device. Access to the volatile memory 506 and the non-volatile memory 508 is controlled by a memory controller.

The processor 502 of the illustrated example is also in communication with one or more mass storage device(s) 512 for storing software and/or data. Examples of such mass storage devices 512 include floppy disk drives, hard disk drives, compact disk drives, Blu-ray disk drives, RAID systems, and digital versatile disk (DVD) drives. In the illustrated example of FIG. 5, the mass storage device 512 includes the example memory 212 of FIG. 2.

The processor platform 500 of the illustrated example also includes a user interface circuit 514. The user interface circuit 514 may be implemented by any type of interface standard, such as an Ethernet interface, a universal serial bus (USB), and/or a PCI express interface. In the illustrated example, one or more input device(s) 230 are connected to the user interface circuit 514. The input device(s) 230 permit(s) a user to enter data and commands into the processor 502. The input device(s) 230 can be implemented by, for example, an audio sensor, a camera (still or video), a keyboard, a button, a mouse, a touchscreen, a track-pad, a trackball, isopoint, a voice recognition system, a microphone, and/or a liquid crystal display. One or more output device(s) 232 are also connected to the user interface circuit 514 of the illustrated example. The output device(s) 232 can be implemented, for example, by a light emitting diode, an organic light emitting diode, a liquid crystal display, a touchscreen and/or a speaker. The user interface circuit 514 of the illustrated example may, thus, include a graphics driver such as a graphics driver chip and/or processor. In the illustrated example, the input device(s) 230, the output device(s) 232 and the user interface circuit 514 collectively form the example user interface 210 of FIG. 2.

The processor platform 500 of the illustrated example also includes a network interface circuit 516. The network interface circuit 516 may be implemented by any type of interface standard, such as an Ethernet interface, a universal serial bus (USB), and/or a PCI express interface. In the illustrated example, the network interface circuit 516 facilitates the exchange of data and/or signals with external machines (e.g., a remote server) via a network 518 (e.g., a local area network (LAN), a wireless local area network (WLAN), a wide area network (WAN), the Internet, a cellular network, etc.).

Coded instructions 520 corresponding to FIG. 4 may be stored in the local memory 504, in the volatile memory 506, in the non-volatile memory 508, in the mass storage device 512, and/or on a removable tangible computer readable storage medium such as a flash memory stick, a CD or DVD.

From the foregoing, it will be appreciated that methods and apparatus have been disclosed for generating an estimated Lorenz curve for a dataset based on a frequency value associated with the dataset. Unlike conventional applications, the methods and apparatus disclosed herein generate an estimated Lorenz curve for a dataset without accessing underlying data obtained from the individual members of the population. As a result of the disclosed methods and apparatus, any confidentiality and/or privacy concern(s) associated with accessing the underlying data obtained from the individual members of the population is/are reduced and/or eliminated. By enabling the generation of an estimated Lorenz curve for a dataset based only on a frequency value associated with the dataset, the disclosed methods and apparatus further provide a computational advantage relative to the voluminous processing and/or storage loads associated with conventional methods for generating a Lorenz curve.

Apparatus for estimating a Lorenz curve for a dataset representing a distribution of products for a population are disclosed. In some disclosed examples, the apparatus comprises a frequency identifier to determine a frequency value associated with the dataset. In some disclosed examples, the apparatus further comprises a Lorenz curve generator to generate an estimated Lorenz curve for the dataset based on a Lorenz curve estimation function including the frequency value.

In some disclosed examples, the frequency identifier of the apparatus includes a frequency calculator to calculate the frequency value associated with the dataset. In some disclosed examples, the frequency calculator is to calculate the frequency value based on an occurrence value associated with the dataset and a population value associated with the dataset.

In some disclosed examples of the apparatus, the Lorenz curve estimation function has the form of Equation 1 described above. In some disclosed examples, the Lorenz curve estimation function is derived from a maximum entropy distribution function. In some disclosed examples, the maximum entropy distribution function has the form of Equation 2 described above.

In some disclosed examples, the apparatus further includes an area calculator to calculate an area under the estimated Lorenz curve. In some disclosed examples, the area calculator is to calculate the area under the estimated Lorenz curve based on an area estimation function including the frequency value associated with the dataset. In some disclosed examples, the area estimation function has the form has the form of Equation 7 described above.

In some disclosed examples, the apparatus further includes a Gini index calculator to calculate a Gini index for the estimated Lorenz curve. In some disclosed examples, the Gini index calculator is to calculate the Gini index for the estimated Lorenz curve based on a Gini index estimation function including the frequency value associated with the dataset. In some disclosed examples, the Gini index estimation function has the form of Equation 8 described above.

In some disclosed examples of the apparatus, the estimated Lorenz curve for the dataset represents an estimated distribution of products purchased by a population of product purchasers. In some disclosed examples of the apparatus, the estimated Lorenz curve for the dataset represents an estimated distribution of webpages visited by a population of webpage viewers. In some disclosed examples of the apparatus, the estimated Lorenz curve for the dataset represents an estimated distribution of media content viewed by a population of media content viewers.

Methods for estimating a Lorenz curve for a dataset representing a distribution of products for a population are disclosed. In some disclosed examples, the method comprises determining, by executing one or more computer readable instructions with a processor, a frequency value associated with the dataset. In some disclosed examples, the method further comprises generating, by executing one or more computer readable instructions with the processor, an estimated Lorenz curve for the dataset based on a Lorenz curve estimation function including the frequency value.

In some disclosed examples of the method, the determining of the frequency value associated with the dataset includes calculating the frequency value based on an occurrence value associated with the dataset and a population value associated with the dataset.

In some disclosed examples of the method, the Lorenz curve estimation function has the form of Equation 1 described above. In some disclosed examples, the Lorenz curve estimation function is derived from a maximum entropy distribution function. In some disclosed examples, the maximum entropy distribution function has the form of Equation 2 described above.

In some disclosed examples, the method further comprises calculating an area under the estimated Lorenz curve. In some disclosed examples, the calculating of the area under the estimated Lorenz curve is based on an area estimation function including the frequency value associated with the dataset. In some disclosed examples, the area estimation function has the form of Equation 7 described above.

In some disclosed examples, the method further comprises calculating a Gini index for the estimated Lorenz curve. In some disclosed examples, the calculating of the Gini index for the estimated Lorenz curve is based on a Gini index estimation function including the frequency value associated with the dataset. In some disclosed examples, the Gini index estimation function has the form of Equation 8 described above.

In some disclosed examples of the method, the estimated Lorenz curve for the dataset represents an estimated distribution of products purchased by a population of product purchasers. In some disclosed examples of the method, the estimated Lorenz curve for the dataset represents an estimated distribution of webpages visited by a population of webpage viewers. In some disclosed examples of the method, the estimated Lorenz curve for the dataset represents an estimated distribution of media content viewed by a population of media content viewers.

Tangible machine-readable storage media comprising instructions are also disclosed. In some disclosed examples, the instructions, when executed, cause a processor to determine a frequency value associated with a dataset. In some disclosed examples, the instructions, when executed, cause the processor to generate an estimated Lorenz curve for the dataset based on a Lorenz curve estimation function including the frequency value.

In some disclosed examples of the tangible machine-readable storage media, the instructions, when executed, cause the processor to determine the frequency value associated with the dataset by calculating the frequency value based on an occurrence value associated with the dataset and a population value associated with the dataset.

In some disclosed examples of the tangible machine-readable storage media, the Lorenz curve estimation function has the form of Equation 1 described above. In some disclosed examples, the Lorenz curve estimation function is derived from a maximum entropy distribution function. In some disclosed examples, the maximum entropy distribution function has the form of Equation 2 described above.

In some disclosed examples of the tangible machine-readable storage media, the instructions, when executed, cause the processor to calculate an area under the estimated Lorenz curve. In some disclosed examples, the instructions, when executed, cause the processor to calculate the area under the estimated Lorenz curve based on an area estimation function including the frequency value associated with the dataset. In some disclosed examples, the area estimation function has the form of Equation 7 described above.

In some disclosed examples of the tangible machine-readable storage media, the instructions, when executed, cause the processor to calculate a Gini index for the estimated Lorenz curve. In some disclosed examples, the instructions, when executed, cause the processor to calculate the Gini index for the estimated Lorenz curve based on a Gini index estimation function including the frequency value associated with the dataset. In some disclosed examples, the Gini index estimation function has the form of Equation 8 described above.

In some disclosed examples of the tangible machine-readable storage media, the estimated Lorenz curve for the dataset represents an estimated distribution of products purchased by a population of product purchasers. In some disclosed examples of the tangible machine-readable storage media, the estimated Lorenz curve for the dataset represents an estimated distribution of webpages visited by a population of webpage viewers. In some disclosed examples of the tangible machine-readable storage media, the estimated Lorenz curve for the dataset represents an estimated distribution of media content viewed by a population of media content viewers.

Although certain example methods, apparatus and articles of manufacture have been disclosed herein, the scope of coverage of this patent is not limited thereto. On the contrary, this patent covers all methods, apparatus and articles of manufacture fairly falling within the scope of the claims of this patent.

1. An apparatus for estimating a Lorenz curve for a dataset representing a distribution of products for individual members of a population, the apparatus comprising:
a frequency identifier to access a frequency value associated with the dataset the frequency value being derived from an occurrence value associated with the products of the dataset and a population value associated with the individual members of the population of the dataset, the frequency identifier to reduce a privacy concern by accessing the frequency value without directly accessing the occurrence value and the population value, the frequency value being associated with a first level of confidentiality that is lower than a second level of confidentiality associated with the occurrence value or the population value; and
a Lorenz curve generator to generate an estimated Lorenz curve for the dataset using a Lorenz curve estimation function including the frequency value.

2. (canceled)

3. The apparatus of claim 1, wherein the Lorenz curve estimation function has the form:
$$y = x - \frac{( 1 - x ) log ( 1 - x )}{f log ( 1 - \frac{1}{f} )}$$
where f is the frequency value.

4. The apparatus of claim 3, wherein the Lorenz curve estimation function is derived from a maximum entropy distribution function.

5. The apparatus of claim 1, further including an area calculator to calculate an area under the estimated Lorenz curve using an area estimation function including the frequency value.

6. The apparatus of claim 5, wherein the area estimation function has the form:
$$Area = \frac{1}{4} ( 2 + \frac{1}{f log ( 1 - \frac{1}{f} )} )$$
where f is the frequency value.

7. The apparatus of claim 1, further including a Gini index calculator to calculate a Gini index for the estimated Lorenz curve using a Gini index estimation function including the frequency value.

8. The apparatus of claim 7, wherein the Gini index estimation function has the form:
$$Gini Index = {( 2 f log ( \frac{f}{f - 1 } ) )}^{- 1}$$
where f is the frequency value.

9. The apparatus of claim 1, wherein the estimated Lorenz curve for the dataset represents an estimated distribution of products purchased by a population of product purchasers.

10. The apparatus of claim 1, wherein the estimated Lorenz curve for the dataset represents an estimated distribution of webpages visited by a population of webpage viewers.

11. The apparatus of claim 1, wherein the estimated Lorenz curve for the dataset represents an estimated distribution of media content viewed by a population of media content viewers.

12. A method to estimate a Lorenz curve for a dataset representing a distribution of products for individual members of a population, the method comprising:
accessing, by executing one or more computer readable instructions with a processor, a frequency value associated with the dataset, the frequency value being derived from an occurrence value associated with the products of the dataset and a population value associated with the individual members of the population of the dataset, the accessing of the frequency value to reduce a privacy concern by occurring without directly accessing the occurrence value and the population value, the frequency value being associated with a first level of confidentiality that is lower than a second level of confidentiality associated with the occurrence value or the population value; and
generating, by executing one or more computer readable instructions with the processor, an estimated Lorenz curve for the dataset using a Lorenz curve estimation function including the frequency value.

13. (canceled)

14. The method of claim 12, wherein the Lorenz curve estimation function has the form:
$$y = x - \frac{( 1 - x ) log ( 1 - x )}{f log ( 1 - \frac{1}{f} )}$$
where f is the frequency value.

15. The method of claim 12, further including calculating an area under the estimated Lorenz curve using an area estimation function including the frequency value.

16. The method of claim 12, further including calculating a Gini index for the estimated Lorenz curve using a Gini index estimation function including the frequency value.

17. A tangible machine-readable storage medium comprising instructions that, when executed, cause a processor to at least:
access a frequency value associated with a dataset representing a distribution of products for individual members of a population, the frequency value being derived from an occurrence value associated with the products of the dataset and a population value associated with the individual members of the population of the dataset, the frequency value to be accessed by the processor without the processor directly accessing the occurrence value and the population value, the accessing to reduce a privacy concern, the frequency value being associated with a first level of confidentiality that is lower than a second level of confidentiality associated with the occurrence value or the population value; and
generate an estimated Lorenz curve for the dataset using a Lorenz curve estimation function including the frequency value.

18. (canceled)

19. The tangible machine-readable storage medium of claim 17, wherein the Lorenz curve estimation function has the form:
$$y = x - \frac{( 1 - x ) log ( 1 - x )}{f log ( 1 - \frac{1}{f} )}$$
where f is the frequency value.

20. The tangible machine-readable storage medium of claim 17, wherein the instructions, when executed, further cause the processor to calculate a Gini index for the estimated Lorenz curve using a Gini index estimation function including the frequency value.

21. The method of claim 14, wherein the Lorenz curve estimation function is derived from a maximum entropy distribution function.

22. The tangible machine-readable storage medium of claim 17, wherein the instructions, when executed, further cause the processor to calculate an area under the estimated Lorenz curve using an area estimation function including the frequency value.

23. The tangible machine-readable storage medium of claim 19, wherein the Lorenz curve estimation function is derived from a maximum entropy distribution function.
